(19) United States
(12) Patent Application Publication
(10) Pub. No.: US 2004/0203847 A1
(43) Pub. Date: Oct. 14, 2004

(54) Location-based task notification

(76) Inventors: Robert C. Knauerhase, Portland, OR (US); Nikhil M. Deshpande, Beaverton, OR (US)

Correspondence Address: BLAKELY, SOKOLOFF, TAYLOR & ZAFMANN LLP, Seventh Floor, 12400 Wilshire Boulevard, Los Angeles, CA, 90025-1030, US

(21) Appl. No.: 10/112,140

(22) Filed: Mar. 28, 2002

(51) Int. Cl. H04Q 7/20

(52) U.S. Cl. 455/456.1; 455/457; 455/566

(57) ABSTRACT

In one aspect of the invention is a method to notify users of wireless devices that tasks in their task list can be satisfied based on the user's location. A user enters a plurality of tasks in a wireless device. As the user travels with the wireless device, the user may pass providers that can satisfy tasks on the user's task list. If the user does, then the user is notified of such information.

### COPYRIGHT NOTICE

A portion of the disclosure of this patent document may contain material which is subject to copyright protection. To the extent that it does, the copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2002, Intel Corporation, All Rights Reserved.

### FIELD

Embodiments of this invention relate to the field of wireless technologies, and more specifically, to a mechanism for notifying a wireless user when the user is in close proximity to a provider so that the user can satisfy an item on the user's task list.

### BACKGROUND

From mobile phones to personal digital assistants (PDAs), wireless devices have transformed a wasteful, yet environmentally conscious society into a world dominated by the capacity to accomplish just about everything electronically. Aside from enabling wireless communication from practically anywhere in the world, wireless devices allow users to tend to financial matters, including personal finances, and monitoring the stock market; to calendar events; and to create task lists.

Creating task lists is not new to most people, and is a well-known concept, both in digital devices and on plain old paper. However, since the task of actually completing items on a task list is subject to human processing (i.e., a user must remember to complete the tasks on the list and/or determine how to prioritize or accomplish the tasks), task lists are often an underutilized concept.

While tickler-type programs exist to help users remember tasks on their task lists, these programs are limited to providing reminders at dates and/or times specified by the user. Unfortunately, such reminders are oftentimes ignored because a reminder may appear at an inopportune time, where the user can't tend to the task at the time, or the reminder is placed in the user's mental checklist for tasks to tend to at a later time, which are then forgotten.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram illustrating a system for location-based task notification in accordance with general embodiments of the invention.

FIG. 2 is a block diagram illustrating components of a location-based task notifier in accordance with general embodiments of the invention.

FIG. 3 is a table illustrating an example of a task database.

FIG. 4 is a table illustrating an example of a provider database.

FIG. 5 is a block diagram illustrating components of a provider for location-based task notification in accordance with general embodiments of the invention.

FIG. 6 is a flow diagram illustrating a wireless device as it travels in the vicinity of providers.

FIG. 7 is a flow diagram illustrating the interaction between a wireless device and a provider, in accordance with one embodiment of the invention.

FIG. 8 is a flow diagram illustrating the interaction between a wireless device, provider, and a location-based services server, in accordance with another embodiment of the invention.

FIG. 9 is a flowchart illustrating a method for location-based task notification in accordance with general embodiments of the invention.

FIG. 10 is a flowchart illustrating a method for location-based task notification in accordance with embodiments of the invention in which a location-based services server is used.

### DETAILED DESCRIPTION

In one aspect of embodiments of the invention is a method for notifying users of wireless devices when the users are in proximity to a provider for performing a task on a task list. Users may specify a number of tasks on a task list in a wireless device, where each task may be satisfied by one or more providers of the task. When a user carries around the wireless device, and comes in proximity to a provider that can satisfy a task on the task list, the user is notified of that fact.

For example, a user may enter the task “buy groceries” on a mobile phone, where the task may be satisfied by one of many providers. When the user is out driving or walking around, and the user comes within some distance of one of the providers, the wireless device may beep, ring, or otherwise notify the user that the user can now satisfy one of the tasks on his task list.

Embodiments of the present invention include various operations, which will be described below. The operations associated with embodiments of the present invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software.

Embodiments of the present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/machine-readable medium suitable for storing electronic instructions.

Moreover, embodiments of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Introduction

As used herein, a wireless device shall refer to any type of mobile device that is capable of knowing its location, such as by GPS (Global Positioning System, where a device is given a latitude/longitude location by a satellite), cellular triangulation (a network of three communication stations where a device can figure out its location based on the radio properties of the device and the three stations), hotspot detection (such as by Institute of Electrical and Electronics Engineers 802.11 access points, discussed infra, where a device knows the location of the access points, and its approximate distance from a given access point; can obtain the information from a server; or can obtain the information from the access point itself), or any combination of these mechanisms. A wireless device may comprise a cell phone, or any type of handheld computing device, for example.

References to a “user” shall imply that the user has in his possession a wireless device having the functionality described herein. Furthermore, providers may comprise entities or individuals that offer services, such as car servicing; or goods, such as groceries. Providers may include hospitals, gas stations, grocery stores, and malls, for example.

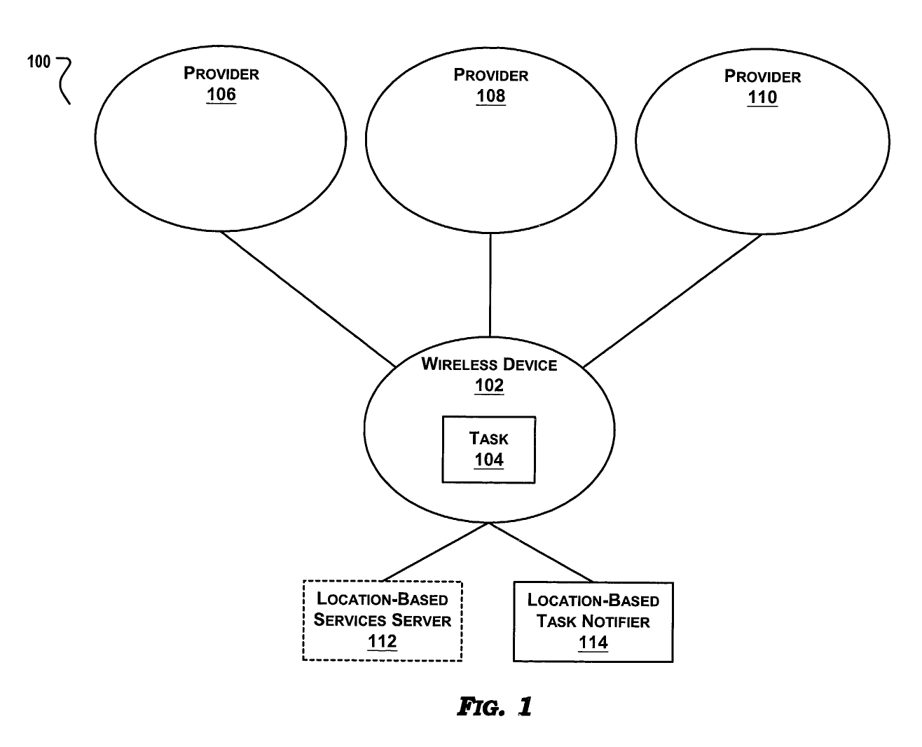

FIG. 1 is a block diagram illustrating a system 100 for location-based task notification in accordance with embodiments of the invention. The system 100 comprises a wireless device 102 having at least one task 104 (only one shown), one or more providers 106, 108, 110 for satisfying the at least one task, and a location-based task notifier 114 for finding providers to satisfy tasks. The system 100 may optionally and additionally comprise a location-based services server 112 for acting as a communication liaison between the wireless device 102 and the providers 106, 108, 110. As the wireless device travels in the proximity of a given provider 106, 108, 110, a user of the wireless device 102 may be notified that one of its tasks 104 may be satisfied.

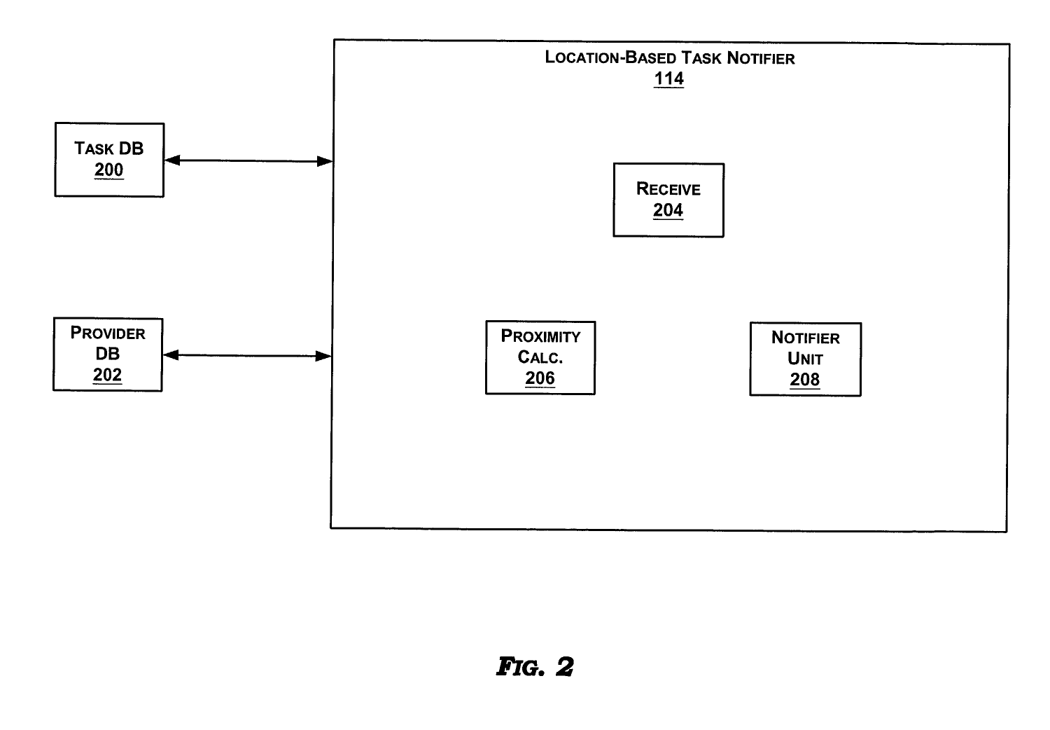

As illustrated in FIG. 2, a location-based task notifier 114 may comprise receiving functionality 204 to receive an indication of a wireless device's location; a proximity calculator 206 to determine if a corresponding provider is in proximity to the wireless device; and a notifier 208 to cause a user to be notified if a corresponding provider exists in proximity to the wireless device.

The location-based task notifier 114 may interface with a task database 200 to determine tasks to be satisfied, and a provider database 202 to determine if a corresponding provider is in proximity to a wireless device. The task database 200 and provider database 202 may both reside on the wireless device 102; may both reside on the location-based services server 112; or may be distributed between the wireless device 102 and the location-based services server 112.

The location-based task notifier 114 may be a virtual module that may have functionality that is distributed. As one of ordinary skill in the art would understand, however, the distribution may vary for different situations. In one embodiment, for example, the location-based task notifier 114 may exist as a standalone module, such as existing completely on the location-based task notifier 114, or completely on the wireless device 102. However, embodiments of the invention are not to be limited to the distribution schemes discussed herein.

### Tasks

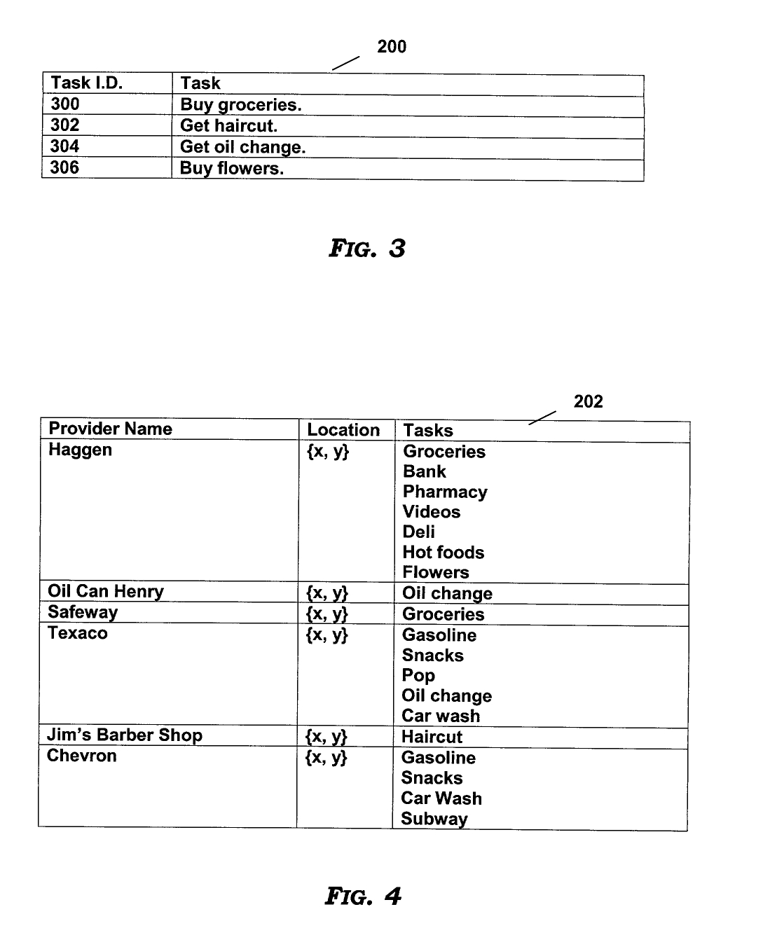

In embodiments of the invention, a user may maintain a list of tasks on a wireless device. The tasks may be entered in free form, or they may be selected from a list of predetermined tasks. FIG. 3 is a table illustrating an example of a task database 200 (also known as a task list). In this example, the task database 200 comprises four tasks identified by task I.D. 300, 302, 304, 306, and task text.

Where a task database 200 is maintained by a location-based services server 112, the task database 200 may correspond to one or more wireless devices 102, where each task 104 in the task database 200 may correspond to one of many wireless devices 102. Where the task database 200 is maintained by a wireless device 102, all tasks 104 in the task database 200 correspond to the wireless device 102.

### Providers

As used herein, a known provider shall be a provider that can be discovered or downloaded. A task may be performed by one or more known providers, where a provider that can satisfy at least one task on a given wireless device's task list is referred to herein as a corresponding provider (regardless of the corresponding provider's proximity to a wireless device). For example, “Arco”, “Conoco”, and “Exxon” may all be corresponding providers for a given wireless device having the task “get gas”. Providers may be maintained in a provider database, where each entry comprises a provider name or identifier (I.D.), and one or more tasks that the provider can perform.

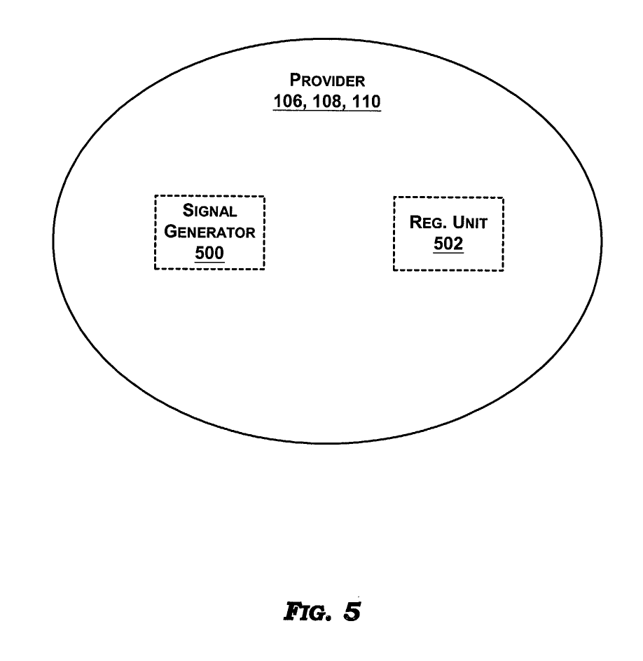

FIG. 4 is a table 202 illustrating an example of a provider database. The table 202 comprises six different providers, where each provider is associated with one or more tasks that it can perform. The table may additionally comprise at least one location for the provider (only one shown), if provider locations are to be maintained in the provider database 202. While table 202 of FIG. 4 only illustrates a single location, it should be understood by one of ordinary skill in the art that the table may comprise a plurality of locations.

The provider database 202 may be populated in a number of ways. In one embodiment, the provider database 202 can be populated by a server (such as the location-based services server 112) performing a location search on various providers (using, for example, a mapping server, such as yp.yahoo.com™), maintaining those locations, and then tracking a device's location and comparing the tracked location to those of the providers. A separate database or server may maintain a list of tasks that given providers can perform so that user tasks may be mapped to appropriate providers.

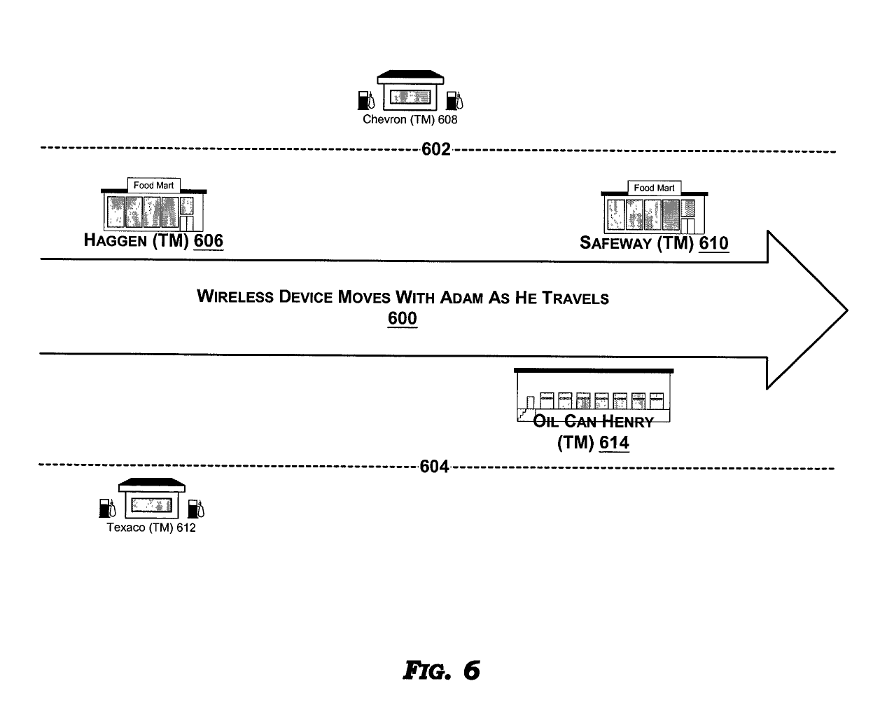

In another embodiment, the provider database 202 can be populated by the devices themselves. In this embodiment, one or more servers maintain a list of providers, corresponding locations, and corresponding tasks that can be performed by a given provider, and a device may download this information so that tasks can be mapped to these locations. In yet another embodiment, as illustrated in FIG. 5, providers of tasks may comprise a registration unit 502 to register their identity and possibly locations with a location-based services server 112. The location-based services server 112 can then compare a wireless device's 102 current location with the registered locations of known providers. In yet other embodiments, a server or a wireless device may download providers and corresponding tasks without locations.

### Determining Proximity

A wireless device is in proximity to a corresponding provider if the current location of the wireless device is within a predetermined distance of a corresponding provider. The predetermined distance may be a default distance provided by the wireless device, for example, or it may be a user-defined distance that the user may modify.

In other embodiments, a wireless device is in proximity to a corresponding provider if the corresponding provider is within a prediction range. A prediction range is any range that can be predicted based on the user's current travel characteristics, such as direction of travel. For instance, if a wireless device is traveling eastbound on Interstate-70, a prediction unit may predict that the wireless device will be heading towards an area in which a corresponding provider exists. In that case, the provider may be brought to the attention of the user.

### Wireless Device's Location

The location of a wireless device may be tracked by the wireless device, or by a location-based services server 112. When tracked by the wireless device, the wireless device knows its location using any of the mechanisms (i.e., GPS, cellular triangulation, or hotspot detection) discussed above, although it is not limited to these mechanisms. When tracked by a location-based services server 112, the wireless device may periodically register its location with a location-based services server 112.

### Notifying the Users

When a corresponding provider in proximity to a wireless device has been determined, a notifier unit 208 causes the user of the wireless device to be notified that a task can be satisfied and given task information. The user can be notified by a reminder unit that is part of a service of a wireless device service provider (as opposed to a goods or services provider of a task). For example, the notifier unit 208 may trigger pager functionality of a wireless device.

In embodiments of the invention, notification may be provided in the form of task information. Task information may comprise one or more tasks that can be satisfied; providers that can satisfy the tasks; and where the providers are located. Embodiments of the invention may furthermore be interfaced with a mapping server, if available (e.g. maps.yahoo.com or mapquest.com) for the purpose of directing the user how to get to the location of a provider from the user's current location.

Determining Corresponding Providers

As a user travels with a wireless device 102, the wireless device's location is received by a receive functionality 204 of the location-based task notifier 114. A proximity calculator 206 can determine if any known providers 106, 108, 110 are corresponding providers by comparing known providers to a task database 200.

When tasks are entered in free form, tasks in a task database 200 may be matched to tasks in a provider database 202 using any text search mechanism. For example, if the user enters “get gas”, a mechanism may discard the verb “get” and find synonyms for or word forms of the subject “gas”, such as “gasoline” or “fuel”. As another example, if a user enters “buy milk”, the verb “buy” may be discarded, and the subject “milk” may be equated to “groceries”. These methods are well-known and are not discussed further so as to not obscure discussion of embodiments of the invention. The filtered text from the task database 200 can then be matched to tasks in a provider database 202.

Alternatively, or in addition, users may select tasks from a list of tasks predetermined and provided by a given wireless device or service provider. Thus, the wireless device or service provider may provide the following tasks that a user may choose from: “buy groceries”; “get haircut”; “get oil change”; “buy flowers”, as shown in the table 200 of FIG. 3. The predefined text from the task database 200 can then be matched to tasks in a provider database 202.

If there are corresponding providers, then it can be determined if they are in proximity to the wireless device's 102 location. In one embodiment, corresponding providers in proximity can be determined by a location-based services server 112 that knows a provider's location using a provider database 202. For example, the wireless device may register its location with a location-based services server 112, and wait for notification from a proximity calculator 206 of the location-based services server 112 that a corresponding provider exists.

In another embodiment, corresponding providers in proximity may be determined by a wireless device 102 by comparing a wireless device's location to a provider's location. A provider's location may be determined by corresponding providers that maintain access points and transmit beacon signals that can be picked up by the devices, where the beacon signals are indicative of a provider's location.

Referring back to FIG. 5, providers of tasks may comprise a signal generator 500 to send out signals to wireless devices, the signals to indicate the provider name and/or I.D., and a location of the provider. For example, any number of “Exxon” gas stations may each house a signal generator 500 that sends out signals at certain times. Wireless devices 102 may intercept the signal, check its provider database 202, and determine if any tasks 104 on its task list can be satisfied by the provider 106, 108, 110.

A signal generator 500 may comprise functionality of an 802.11 hotspot, for example. The IEEE (Institute of Electrical and Electronics Engineers) 802.11 standard (hereinafter “802.11”) is a family of specifications for wireless local area networks (WLANs), and was developed to maximize interoperability between differing brands of wired local area networks (LANs) as well as to introduce a variety of performance improvements and benefits. The 802.11 topology comprises components that interact to provide a wireless LAN that enables station mobility that is transparent to higher protocol layers.

Another way to discover a provider is to establish a handshake between a wireless device 102 and a corresponding provider 106, 108, 110. For example, a wireless device 102 can emit signals as it travels, and the signals are intercepted by known providers. If any of the known providers is a corresponding provider that is within proximity of the wireless device, the corresponding provider transmits a signal back to the wireless device 102 informing the wireless device 102 of its existence, location, and tasks that it can satisfy, for example.

Where providers are determined by discovery, such as by a signal generator or a handshake, the device can store the provider and its discovered location (or locations), or send it to a location-based services server 112. In this manner, if the device is out of its normal range, the provider information may be available for future use.

In embodiments where providers may know when a device is in its proximity (such as when a handshake protocol is used), providers may give incentives to users in their proximity. For example, if a user is notified that a provider is in proximity, and the provider is also aware of this, the provider may incent the user to actually stop by providing discounts, coupons, freebies, etc.

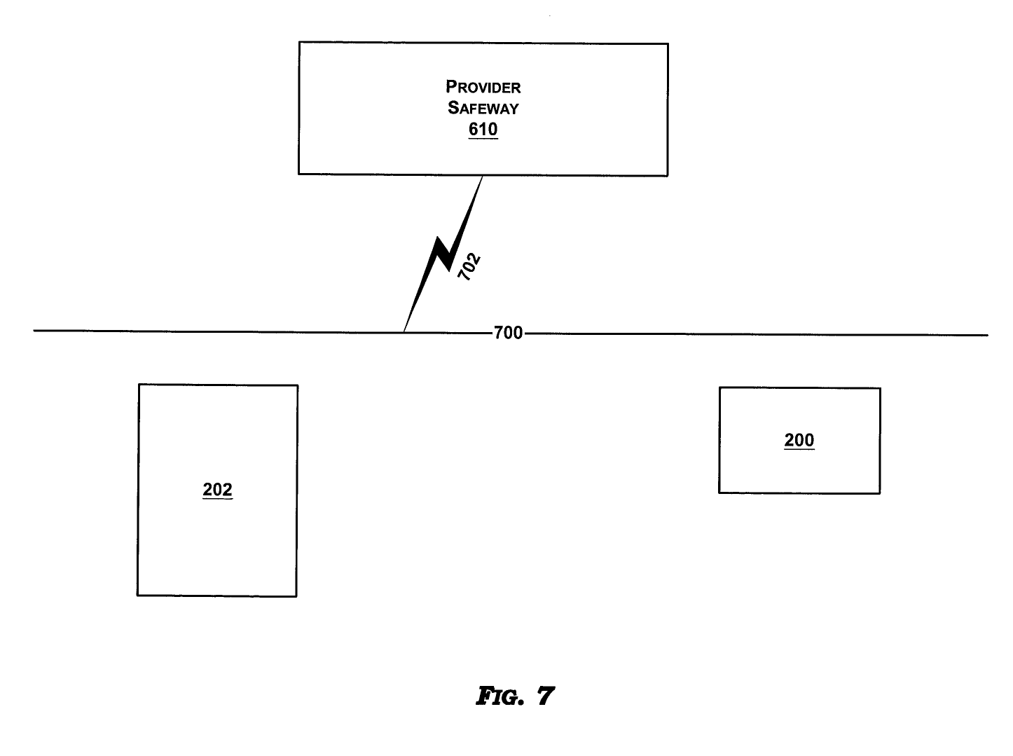

FIG. 6 is a flow diagram illustrating a wireless device traveling eastbound (depicted by 600). The area bound by lines 602, 604 indicate areas of proximity to the wireless device. As the wireless device travels 600, it passes several known providers 606, 608, 610, 612, 614. Of those known providers, some are corresponding providers (as determined by a task database 200 and provider database 202 corresponding to the wireless device), and some are corresponding providers 606, 610, 614 within proximity of the wireless device 102.

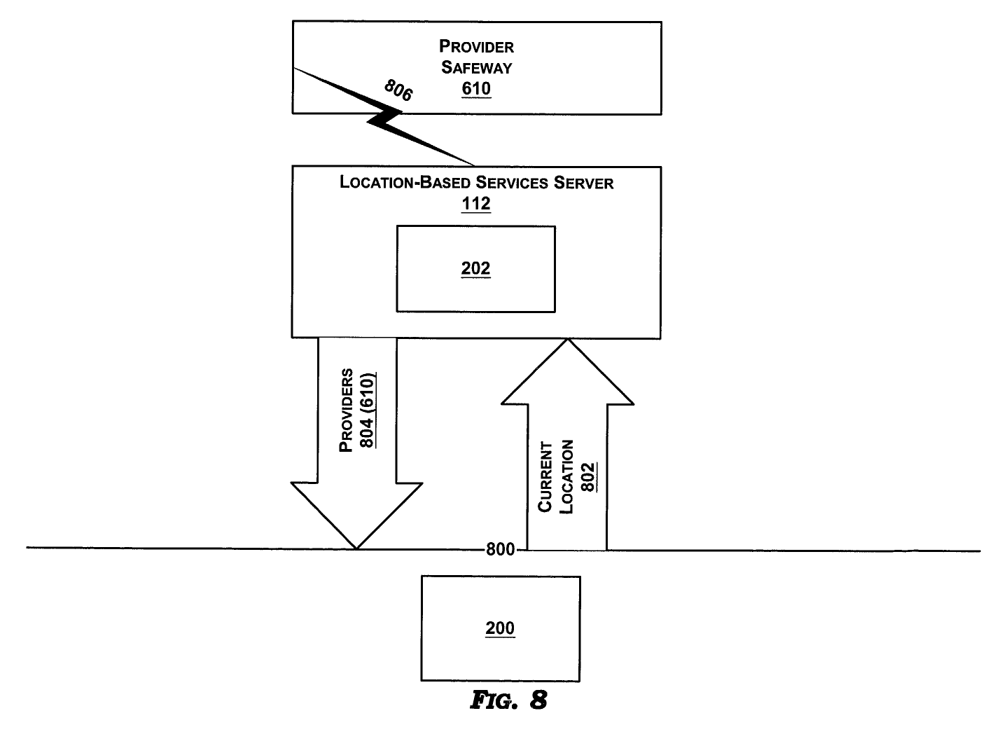

FIG. 7 illustrates one embodiment of determining a provider for a task on a wireless device's 102 task list 104. In this illustration, line 700 separates the provider 610 from the wireless device's 102 provider database 202 and task database 200. In this embodiment, a provider “Safeway” 610 transmits a signal 702 as the wireless device 102 travels. The signal 702 is intercepted by the wireless device 102 and compared to its provider database 202. Since provider “Safeway” 610 corresponds to task “groceries”, the task “groceries” is compared to the task database 200. Using a text search mechanism (examples discussed above), the provider task “groceries” is matched to the user task “buy groceries”. Provider “Safeway” may, of course, correspond to multiple tasks. Where a provider can satisfy multiple tasks, those tasks may be compared to the user's task list 104, and the user may be notified that the provider can satisfy any number of those tasks.

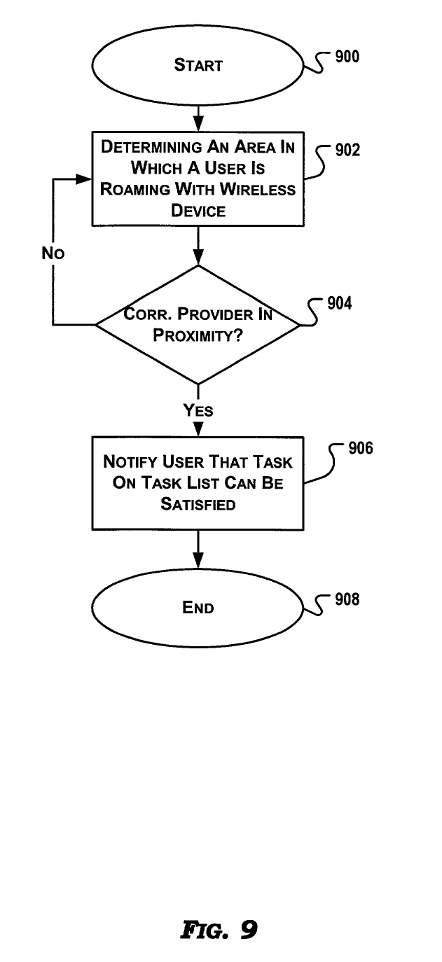

FIG. 8 illustrates another embodiment of determining a provider for a task on a wireless device's 102 task list 104. In this illustration, line 800 separates the provider 610 from the wireless device's task database 200. Furthermore, a location-based services server 112 comprises a provider database 202, and either receives a signal 806 from a known provider 610, or maintains in its provider database 202 some or all locations for the known provider 610. In this embodiment, a wireless device 102 registers its current location 802 as it travels.

The location-based services server 112 compares the current location 802 to its provider database 202. If a provider exists in proximity to the wireless device 102 (as determined by a proximity calculator 206, for instance), then the location-based services server 112 returns the provider 804 (or providers, which may include provider 610, for example) to the wireless device 102. The wireless device 102 may then determine whether the provider is a corresponding provider based on its task list. If it is a corresponding provider, then the user is notified that one or more tasks may be satisfied.

Note that in this example, a provider's proximity is determined before determining whether the provider is a corresponding provider. However, it may first be determined if a corresponding provider exists, and then whether that corresponding is in proximity to the wireless device. It should be apparent to one of ordinary skill at this point that the order of these determinations is not important.

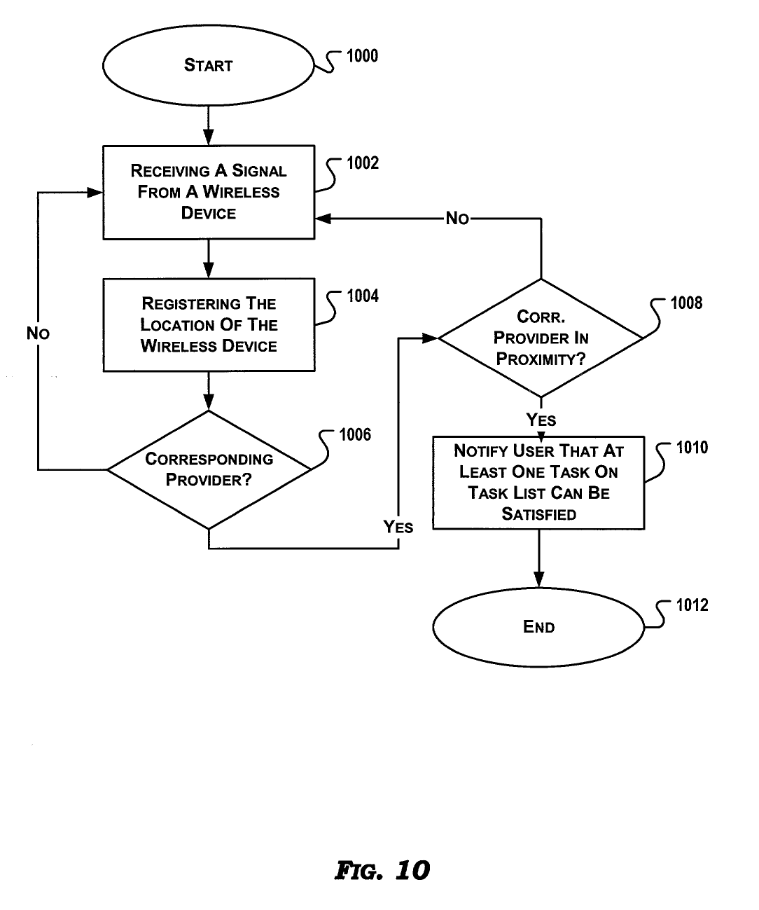

FIG. 9 is a flowchart illustrating a method for location-based task notification in accordance with general embodiments of the invention. The method begins at block 900 and continues to block 902 where an area in which a user is traveling with a wireless device is determined. In embodiments of the invention, determining an area in which a user is traveling may comprise receiving location information from a location detection mechanism of the wireless device.

At block 904, it is determined if a corresponding provider exists within a proximity of the determined area. If a corresponding provider exists at block 904, then at block 906, the user of the wireless device is notified that a task on the task list can be satisfied. If no corresponding provider exists, then the method may be repeated at block 902. The method ends at block 908.

FIG. 10 is a flowchart illustrating a method for location-based task notification in accordance with embodiments of the invention in which a location-based services server 112 is used. The method begins at block 1000 and continues to block 1002 where a signal is received from a wireless device. At block 1004, the wireless device's location is registered.

At block 1006, it is determined if a corresponding provider exists. If a corresponding provider exists, then at block 1008 it is determined if the corresponding provider is within proximity of the wireless device's location based on the registered location. (As discussed above, the order of determinations at block 1006 band block 1008 may be reversed.) If it is a corresponding provider within proximity, then at block 1010, the user is notified that a task on its task list can be satisfied. If it is not a corresponding provider then the method may repeat at block 1002. The method ends at block 1012.

### CONCLUSION

In the foregoing specification, the invention has been described with reference to specific embodiments thereof. It will, however, be evident that various modifications and changes may be made thereto without departing from the broader spirit and scope of embodiments of the invention. The specification and drawings are, accordingly, to be regarded in an illustrative rather than a restrictive sense.

What is claimed is:

1. A method comprising:
receiving an indication of an area in which a user is traveling with a wireless device having a task list with tasks;
determining if a corresponding provider exists within a proximity of the area; and
if a corresponding provider exists in the proximity of the area, causing the user to be notified that at least one of the tasks on the task list can be satisfied.

2. The method of claim 1, wherein the proximity of the area comprises a predetermined distance.

3. The method of claim 1, wherein the proximity of the area comprises a prediction range.

4. The method of claim 1, wherein said causing the user to be notified that at least one of the tasks on the task list can be satisfied comprises triggering pager functionality of the wireless device.

5. The method of claim 1, wherein said causing the user to be notified that at least one of the tasks on the task list can be satisfied additionally comprises causing task information to be provided to the user.

6. The method of claim 5, wherein the task information comprises:
at least one task on the task list that can be satisfied;
a provider that can satisfy each of the at least one task; and
a location of each provider.

7. The method of claim 1, wherein said determining if a corresponding provider exists within proximity of the area comprises receiving a signal from a corresponding provider that exists within proximity of the area.

8. The method of claim 1, wherein said determining if a corresponding provider exists within proximity of the area comprises:
registering a current location of the wireless device with a location-based services server;
receiving notification from the location-based services server that a corresponding provider exists within proximity of the area.

9. A method comprising:
receiving a signal from one of at least one wireless device, the signal indicative of a location of the one wireless device, and the wireless device having at least one task in a task list;
registering the location of the wireless device;
determining if any corresponding providers exist;
if corresponding providers exist, determining if the corresponding providers exist in proximity to the location of the wireless device; and
if corresponding providers exist in proximity to the location of the wireless device, then causing a user of the wireless device to be notified that at least one task on the task list can be satisfied.

10. The method of claim 9, wherein said determining if the corresponding providers exist in proximity to the location of the wireless device comprises determining if the registered location of the wireless device is within a specified distance of the corresponding providers.

11. The method of claim 9, wherein said determining if any corresponding providers exist comprises comparing tasks corresponding to the providers to the at least one task in the task database.

12. An apparatus comprising:
receiving functionality to receive an indication of a wireless device's location;
a proximity calculator to determine if a corresponding provider exists in proximity to the wireless device; and
a notifier to cause a user of the wireless device to be notified if a corresponding provider exists in proximity to the wireless device.

13. The apparatus of claim 12, wherein the proximity calculator determines if a corresponding provider exists in proximity to the wireless device by comparing the location of the wireless device to a location of the corresponding provider, the location of the corresponding provider being determined by periodically receiving a signal from the wireless device.

14. The apparatus of claim 13, wherein the proximity calculator determines if a corresponding provider exists in proximity to the wireless device by determining if the location of the wireless device is within a prediction range from the location of the corresponding provider.

15. The apparatus of claim 12, wherein the proximity calculator determines if a corresponding provider exists in proximity to the wireless device by comparing the location of the wireless device to a location of the corresponding provider, the location of the corresponding provider being determined from a signal generated by the corresponding provider.

16. A system comprising:
a location detection mechanism to determine the location of a wireless device;
a location-based task notifier communicatively coupled to the location detection mechanism to determine if a corresponding provider exists in proximity to the wireless device based on the location of the wireless device, and to cause a user of the wireless device to be notified if a corresponding provider exists in proximity to the wireless device; and
a reminder unit communicatively coupled to the location-based task notifier to notify a user of the wireless device that a corresponding provider exists in proximity to the device, and to notify the user of that fact.

17. The system of claim 16, wherein the system comprises a location-based services server, and the location detection mechanism determines the location of the wireless device from a provider database.

18. The system of claim 17, wherein the location detection mechanism additionally registers the location of the wireless device based on the received signal.

19. The system of claim 16, wherein the system comprises a wireless device, and the location-based task notifier determines if a corresponding provider is in proximity to the wireless device by comparing the location of the wireless device to a location of the corresponding provider, the location of the corresponding provider being determined by periodically receiving a signal from the wireless device.

20. A machine-readable medium having stored thereon data representing sequences of instructions, the sequences of instructions which, when executed by a processor, cause the processor to perform the following:
receive an indication of an area in which a user is traveling with a wireless device having a task list with tasks;
determine if a corresponding provider exists within a proximity of the area; and
if a corresponding provider exists in the proximity of the area, cause the user to be notified that at least one of the tasks on the task list can be satisfied.

21. The machine-readable medium of claim 20, wherein the proximity of the area comprises a prediction range.

22. The machine-readable medium of claim 20, wherein said determining if a corresponding provider exists within proximity of the area comprises receiving a broadcast from a corresponding provider that exists within proximity of the area.

23. The machine-readable medium of claim 20, wherein said determining if a corresponding provider exists within proximity of the area comprises:
registering a current location of the wireless device with a location-based services server;
receiving notification from the location-based services server that a corresponding provider exists within proximity of the area.

24. An apparatus comprising:
at least one processor; and
a machine-readable medium having instructions encoded thereon, which when executed by the processor, are capable of directing the processor to:
receive indication of an area in which a user is traveling with a wireless device having a task list with tasks;
determining if a corresponding provider exists within a proximity of the area; and
if a corresponding provider exists in the proximity of the area, causing the user to be notified that at least one of the tasks on the task list can be satisfied.

25. The apparatus of claim 24, wherein the proximity of the area comprises a prediction range.

26. The apparatus of claim 24, wherein said determining if a corresponding provider exists within proximity of the area comprises:
registering a current location of the wireless device with a location-based services server;
receiving notification from the location-based services server that a corresponding provider exists within proximity of the area.

27. An apparatus comprising:
means for receiving an indication of a wireless device's location;
means for determining if a corresponding provider exists in proximity to the wireless device; and
means for causing a user of the wireless device to be notified if a corresponding provider exists in proximity to the wireless device.

28. The apparatus of claim 27, wherein the means for determining if a corresponding provider exists in proximity to the wireless device comprises means for comparing the location of the wireless device to a location of the corresponding provider, the location of the corresponding provider being determined from by periodically receiving a signal from the wireless device.

29. The apparatus of claim 28, wherein the means for determining if a corresponding provider exists in proximity to the wireless device comprises means for determining if the location of the wireless device is within a prediction range from the location of the corresponding provider.
